(19) United States
(12) Patent Application Publication
(10) Pub. No.: US 2015/0291750 A1
(43) Pub. Date: Oct. 15, 2015

(54) TRANSPARENT FILM

(71) Applicant: DSM IP ASSETS B.V., Heerlen (NL)

(72) Inventors: Hendricus Franciscus AUSSEMS, Echt (NL); Antonius Maria VET, Echt (NL); Paul Willem Jan VAN DEN HEUVEL, Echt (NL)

(21) Appl. No.: 14/443,264

(22) PCT Filed: Nov. 12, 2013
(86) PCT No.: PCT/EP2013/073596

§ 371 Date: May 15, 2015

(30) Foreign Application Priority Data
Nov. 19, 2012 (EP) 12193239.6

(51) Int. Cl. C08J 5/18; B65D 65/02; B29C 47/00

(52) U.S. Cl. CPC C08J 5/18; B29C 47/0004; B29C 47/0021; B65D 65/02; C08J 2367/08; B29L 2007/008

(57) ABSTRACT

Film containing at least a first layer comprising a copolymer containing monomer units of a dimerised fatty acid or a derivative thereof, wherein the first layer has a thickness of at least 75 μm and the first layer has a haze as measured by ASTM D1003-11 Procedure A of at most 30%. The film can be used for decorative packaging, deep drawn packaging or decorative films.

The present invention relates to a transparent film containing at least a first layer comprising a copolymer containing monomer units of a dimerised fatty acid or a derivative thereof. The invention further relates to a method of making such a film and the use of the film in packaging and for decoration.

In many applications it is important to use films that have sufficient transparency. When used for packaging, the transparent film allows that the content of the packaging is well visible to the user. A good transparency also allows applying clearly distinguishable decorations onto the film.

A drawback of existing films is that although they may appear transparent at first sight, the transparency disappears upon handling the film, e.g by bending. Also, sometimes the film will be submitted to a heat treatment, which could affect the transparency.

According to the present application it has now been found that the above drawbacks can be overcome by a film containing at least a first layer comprising a copolymer containing monomer units of a dimerised fatty acid or a derivative thereof, wherein the first layer has a thickness of at least 75 μm and the first layer has a haze as measured by ASTM D1003-11 Procedure A of at most 30%.

The copolymer containing monomer units of a dimerised fatty acid or derivative thereof is also described in WO2011/036051 for cooking bags. Using the blow molding methods described in this document for obtaining a film, relatively thin films are obtained that are not sufficient for the purposes of the present invention.

Surprisingly, it was found that by the manufacturing methods as described below, relatively thick, transparent films can be obtained.

The dimerised fatty acids in the copolymer forming the first layer, may be obtained from monomeric unsaturated fatty acids by an oligomerisation reaction. The oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acids are saturated.

It is also possible that the copolymer of the first layer contains monomer units of derivatives of dimerised fatty acid. For example a dimerised fatty diol may be obtained as a derivative of the dimerised fatty acid by hydrogenation of the carboxylic acid groups of the dimerised fatty acid, or of an ester group made thereof. Further derivatives may be obtained by converting the carboxylic acid groups, or the ester groups made thereof, into an amide group, a nitril group, an amine group or an isocyanate group.

The dimerised fatty acids may contain from 32 up to 44 carbon atoms. Preferably the dimerised fatty acid contains 36 carbon atoms.

Further details relating to the structure and the properties of the dimerised fatty acids may be found in the corresponding leaflet “Pripol C36-Dimer acid” of the company UNICHEMA (Emmerich, Germany) or in the brochure of the Company COGNIS (Dusseldorf, Germany) “Empol Dimer and Poly-basic Acids; Technical Bulletin 114C (1997)”.

In the production of the copolymer of the first layer the dimerised fatty acid can be used as a monomer or as a pre-cursor oligomer or polymer. In one example the pre-cursor polymer is a polyester, formed of dimerised fatty acid and/or dimerised fatty diol with any combination of diols or dicarboxylic acids. In another example the pre-cursor polymer is a polyamide, formed of dimerised fatty acid and/or dimerised fatty diamines with any combination of diamines or dicarboxylic acids forming polyamides. It is also possible that the pre-cursor polymer is a polyester-amide.

The copolymer of the first layer has in general a softening temperature, i.e. a glass transition temperature or a melting temperature, higher than 100° C., more preferably higher than 150° C. Preferably the copolymer has a semi-crystalline character, resulting in improved chemical resistance of the copolymer. Suitable copolymers for the first layer according to the invention include polyurethanes, polyamides or polyesters.

Preferably the copolymer of the first layer is a polyester containing further monomer units of at least one dicarboxylic acid and at least one diol. The dicarboxylic acid may be aliphatic or aromatic. Suitable aliphatic dicarboxylic acids include oxalic acid, succinic acid, fumaric acid, suberic acid, sebacic acid and cyclohexane dicarboxylic acid. Suitable aromatic dicarboxylic acids include terephthalic acid, isophthalic acid, ortho-phthalic acid, naphthalene-dicarboxylic acid and para-phenylene dicarboxylic acid. Preferably at least one aromatic dicarboxylic acid is terephthalic acid or naphthalene dicarboxylic acid. Preferably at least 80 mol. %, more preferably at least 90 mol. %, most preferably at least 98 mol. % of the monomer units of dicarboxylic acids of the further monomer units are one or more aromatic dicarboxylic acids. The balance of the dicarboxylic acids of the further monomer units may contain of aliphatic dicarboxylic acids.

Suitable aliphatic diols include for example ethylene glycol, 1,3-propylene glycol, 1,4-butanediol, 1,6-hexanediol, neopentyl glycol, trimethylene glycol, tetramethylene glycol, cyclohexane dimethanol. An example of a suitable aromatic diol is 2,2-bis (4-hydroxyphenyl) propane. Sugar based diols, like for instance isosorbide, isomannite or isoidide may also be used. Preferably greater than 50, more preferably greater than 70, particularly greater than 90, and especially greater than 95 and up to 100 mole % of the diols are aliphatic glycol (s), preferably ethylene glycol and/or 1,4-butanediol.

In a particularly preferred embodiment of the invention, the further monomer units are 1,4-butanediol and terephthalic acid, ethylene glycol and terephthalic acid, ethylene glycol and naphthalene dicarboxylic acid, 1,4-butanediol and naphthalene dicarboxylic acid or mixtures thereof. Most preferably the further monomer units are 1,4-butanediol and terephthalic acid.

The copolymer of the first layer may further contains units of one or more polyether diols, for example poly(ethylene glycol), poly(propylene glycol), more particular poly-1,3-propylene glycol or poly-1,2-propylene glycol, poly(tetramethylene glycol), poly(hexamethyleneglycol), poly(ethylene glycol-tetramethylene glycol)copolymer, poly(ethylene glycol-propylene glycol)copolymers etc.

Preferably the copolymer consists of monomeric units of dimerised fatty acid and/or one or more derivatives thereof, 1,4-butanediol and terephthalic acid.

The ratio between the monomer units of dimerised fatty acid and/or one or more derivatives and the further monomer units in the copolymer of the first layer may in general vary between wide limits but is chosen particularly on the basis of the desired hardness of the copolymer. The hardness lies in general between 20 and 90 Shore D.

Preferably the copolymer contains between 2 and 60 wt. % of the monomer units of the dimerised fatty acid and/or a derivative thereof, more preferably between 5 and 40 wt. %, even more preferably between 10 and 30 wt. %. This ensures a high melting point of the copolymer and a high flexibility and good low temperature properties.

Examples of the preparation of such copolymers are described in for example Handbook of Thermoplastics, etc. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996) ISBN 1-56990-205-4, in Encyclopaedia of Polymer Science and Engineering, Vol. 12, Wiley & Sons, New York (1988), ISBN 0-471-80944, p. 75-117 and the references cited therein. Also referred to is W02011/036051, which is incorporated by reference in as far as the preparation of the copolymer is concerned.

During or after the production of the copolymer additives may be added. These additives can function as anti-oxidants, UV-absorbers, nucleating agents, dies or pigments, inorganic or organic fillers, and anti-static agents. Stabilizers that can be used for example are hindered phenol antioxidants such as 1,3,5-trimethyl-2,4,6-tris(3,5,-di-t-butyl-4-hydroxybenzyl) benzene, and 3,9-bis{2-[3-(3-t-butyl-4-hydroxy-5-methylphenyl)-propionyloxyl-1,I-dimethylethyl}-2,4,8,10-tetraoxaspiro[5,5] undecane or stabilizers such as tris(2,4-di-t-butylphenyl)phosphite, trilauryl phosphite, 2-t-butyl-alpha-(3-t-butyl-4-hydroxyphenyl)-p-cumenyl-bis(pnonylphenyl) phosphite, Examples of the above inorganic fillers are, for example, calcium carbonate, titanium oxide, mica, talc, and so on. Examples of the above ultraviolet absorbers include, for example, p-t-butylphenyl salicylate, 2-hydroxy-4-methoxybenzophenone, 2-hydroxy-4-methoxy-2′-carboxybenzophenone, 2,4,5-trihydroxy-butylophenone, and so on. Examples of the above nucleating agents are talcum, carboxylic acid salts like sodium benzoate and sodium stearate, titanium oxide and so on. Examples of anti-blocking agents are synthetic and natural silica's, talcum, zeolites and fatty amides.

As described above, the first layer of the film of the invention has a thickness of at least 75 μm. Preferably the thickness is at least 100 μm, more preferably at least 150 μm. There is no particular upper limit for the thickness of the first layer, but for further processing of the film in packaging, in general, the thickness of the film is at most 1000 μm, preferably at most 750 μm.

The haze of the first layer of the film as measured by ASTM D1003-11 Procedure A of at most 30%. Preferably the haze is as low as possible, i.e. at most 25%, or even at most 20%. Thus, the lower the haze value of the film, the more transparent the film is.

A further advantage of the film of the invention is that the transparency of the first layer is maintained even after handling of the film, e.g. by deep drawing packaging or by heating the film. In particular exposing the first layer to a high temperature for a certain amount of time shows this stability of the transparency. Thus, according to the invention, the first layer has an increase in haze after heating for 15 minutes at 160° C. of at most 10%, preferably at most 5%.

The film of the invention may further contain a second layer. The second layer can be any polymer that is commonly used in the field, e.g. a polyamide, such as polyamide (PA) 6, PA 6,6, PA4,10 or PA12, or thermoplastic polyurethane (TPU). The second layer can be adhered to the first layer by means of a suitable adhesive. Alternatively, in a preferred embodiment of the invention, the second layer is a TPU and is co-extruded with the first layer.

When the film of the invention is provided with a decoration or is printed, this decoration or print is applied to the first layer comprising a copolymer containing monomer units of a dimerised fatty acid or a derivative thereof. The second layer is thereafter applied onto the decorated or printed first layer.

The film of the invention can be used for several purposes, but in particular for decorative packaging, deep drawn packaging or decorative films.

The film containing at least a first layer comprising a copolymer containing monomer units of a dimerised fatty acid or a derivative thereof the invention can be manufactured by conventional methods. In particular the first layer should be manufactured such that the required haze is obtained.

According to a second aspect the present invention thus provides a method for manufacturing a first layer of the film according to any of the preceding claims, comprising the steps of
heating the copolymer containing monomer units of a dimerised fatty acid or a derivative thereof to a temperature above the melting point of the copolymer in an extruder
forming a layer of the melted copolymer by passing the copolymer through a die cooling the layer rapidly to a temperature at least 50° C. below the crystallization temperature of the copolymer.

Rapid cooling means that the layer reaches the temperature of at least 50° C. below the crystallization temperature of the copolymer as quickly as possible. In particular cooling can take place in 60 seconds or less, preferably 30 seconds or less, or even 15 seconds or less. Using suitable equipment as known to a skilled person, cooling times of as fast as 1 second can be achieved. Examples of suitable equipment are cooled rollers, cooling by blowing a cool gas onto the layer and cooling with water.

As described above, the first layer is cooled to a temperature at least 50° C. below the crystallization temperature of the copolymer. Crystallization temperatures can be determined by conventional methods, such as DSC. In general, for the copolymer of the invention the crystallization temperature is from 100 to 200° C. The temperature to which is the layer is cooled can be 10-40° C., preferably 10-30° C.

Test Methods Haze was determined according to ASTM D1003-11 Procedure A

“Standard Test Method for Haze and Luminous Transmittance of Transparent Plastics. A Hazegard System XL-211 was used for the measurements.

### EXAMPLES

### Materials Used:

Arnitel Eco L-X07011, a commercial grade polymer of DSM, according to the invention

Arnitel EM630, a commercial grade polymer of DSM, copolyetherester containing soft segments based on polytetrahydrofuran

### PET, a Commercial Grade

Each of the materials of the examples (see Table 1) was processed to a film in a Collin cast film line. The equipment consisted of an extruder, a feed block and a die. The extruder had a 30 mm barrier screw with a length of 30D. The die had a slit opening, 300 mm wide and 0.5 mm high.

The temperature at the head of the extruder was set at 280° C. At the exit of the die the film was cooled to 20° C. using water and by collecting the film on rollers of 20° C.

TABLE 1

| | | Thickness | Transmit- | Haze |
|---|---|---|---|---|
| Example | Material | (μm) | tance (%) | (%) |
| 1 | Arnitel Eco L-X07011 | 205 | 91.3 | 7.6 |
| 2 | Arnitel Eco L-X07011 | 302 | 86.7 | 15.2 |
| Comp. A | Arnitel EM630 | 295 | 73 | 48 |

The examples listed in Table 1 surprisingly show that the films of the invention show a much better transparency than state of the art copolyetherester films.

TABLE 2

| | | Thickness | Transmit- | Haze |
|---|---|---|---|---|
| Example | Material | (μm) | tance (%) | (%) |
| 3 | Arnitel Eco L-X07011 | 222 | 90.4 | 3.3 |
| 4 | Ex. 3 after exposure to | 222 | 88.9 | 5.4 |
| | 160° C. for 15 minutes | | | |
| Comp. B1 | PET | 518 | 90.4 | 1.8 |
| Comp. B2 | Comp. B1 after exposure to | 518 | 52.2 | >100 |
| | 160° C. for 15 minutes | | | |

The examples listed in Table 2 show that where commercial grade PET undergoes whitening after exposure to heat, the copolymer of the present invention retains its transparency.

1. Film containing at least a first layer comprising a copolymer containing monomer units of a dimerised fatty acid or a derivative thereof, wherein the first layer has a thickness of at least 75 μm and the first layer has a haze as measured by ASTM D1003-11 Procedure A of at most 30%.

2. Film according to claim 1, wherein the copolymer is a polyester containing monomer units of a dimerised fatty acid or a derivative thereof and containing further monomer units of at least one dicarboxylic acid and at least one diol.

3. Film according to claim 2, wherein the further monomer units are monomer units of terephthalic acid and 1,4-butanediol.

4. Film according to claim 1, wherein the copolymer has a hardness of between 20-90 shore D.

5. Film according to claim 1, wherein the copolymer contains between 2 and 40 wt. % monomer units of a dimerised fatty acid and/or a derivative thereof based on the total weight of the copolymer.

6. Film according to claim 1, wherein the first layer has a thickness of at least 100 μm, preferably at least 150 μm.

7. Film according to claim 1, wherein the first layer has a haze of at most 25%.

8. Film according to claim 1, where in the first layer has an increase in haze after heating for 15 minutes at 160° C. of at most 10%, preferably at most 5%.

9. Use of a film according to claim 1, for decorative packaging, deep drawn packaging or decorative films.

10. Method for manufacturing a first layer of the film according to claim 1, comprising the steps of
heating the copolymer containing monomer units of a dimerised fatty acid or a derivative thereof to a temperature above the melting point of the copolymer in an extruder
forming a layer of the melted copolymer by passing the copolymer through a die cooling the layer rapidly to a temperature at least 50° C. below the crystallization temperature of the copolymer.

11. Method according to claim 10, wherein the cooling of the film to a temperature at least 50° C. below the crystallization temperature of the copolymer takes place in 60 seconds or less, preferably 30 seconds or less, most preferably 10 seconds or less.

12. Method according to claim 10, wherein the layer is cooled to a temperature of 10-40° C., preferably 10-30° C.
